(19) United States
(12) Patent Application Publication
(10) Pub. No.: US 2015/0178683 A1
(43) Pub. Date: Jun. 25, 2015

(54) SYSTEMS AND METHODS TO SELECT PARTICIPANTS IN A PROGRAM TO SUSTAINABLY EXIT POVERTY

(71) Applicant: The Blessing Basket Project, St. Louis, MO (US)

(72) Inventors: Theresa Carrington, Edwardsville, IL (US); Charles Grady, St. Louis, MO (US); Timothy J. Ernst, St. Louis, MO (US)

(73) Assignee: The Blessing Basket Project, St. Louis, MO (US)

(21) Appl. No.: 14/138,460

(22) Filed: Dec. 23, 2013

(51) Int. Cl. G06Q 10/10; G06F 17/30

(52) U.S. Cl. CPC G06Q 10/1057; G06F 17/30707

(57) ABSTRACT

A computer-implemented method for selecting participants from an applicant pool to participate in a program to exit poverty is described. The method implemented using a computing device in communication with a memory. The method includes storing a plurality of questions to ask each applicant from a pool of applicants, storing a plurality of ratings based on historical data wherein each rating is associated with each of one or more potential answers for each question of the plurality of questions, compiling by the computing device one or more scores for the applicant based on the applicant's answers to the plurality of questions and the plurality of ratings, calculating by the computing device the applicant's overall score based on the one or more scores, determining the applicant's ranking in comparison to the pool of applicants, and outputting the rankings of the applicants.

### BACKGROUND OF THE DISCLOSURE

The field of the disclosure relates generally to selecting applicants for participation in a program, and more particularly to a selection process to facilitate choosing participants who are most likely to succeed at a program that enables such participants to earn a wage and work their way out of poverty.

Numerous organizations have established programs that provide assistance for those living in poverty. While many programs do provide at least some temporary relief for some people living in poverty, such programs are not necessarily focused on providing assistance in a manner that can assist individuals living in poverty to sustainably exit poverty. Rather, such programs address immediate needs such as providing food, water and shelter, and the relief provided is temporary, e.g., limited resources are available under such programs. While there certainly is a need for programs that provide such assistance, these programs are not necessarily focused on assisting individuals in sustainably exiting poverty.

In addition, many known programs generally focus on providing aid to all those living in poverty in a particular geographic area or on a specific circumstance at least partly attributable to causing poverty. As a result, aid may be provided across a broad population within the selected geography or a broad population exposed to the selected circumstance. Within such a broad population, at least some of those receiving aid are not willing, are not prepared, or lack an understanding of how to use the aid as a support mechanism out of poverty. Such aid can even be subject to abuse.

### BRIEF DESCRIPTION OF THE DISCLOSURE

In one aspect, a computer-implemented method for selecting participants from an applicant pool to participate in a program to exit poverty is described. The method is implemented using a computer device in communication with a memory. The method includes storing in the memory a plurality of questions to ask each applicant from a pool of applicants, storing in the memory a plurality of ratings based on historical data wherein each rating is associated with each of one or more potential answers for each question of the plurality of questions, compiling by the computing device one or more scores for the applicant based on the applicant's answers to the plurality of questions and the plurality of ratings, calculating by the computing device the applicant's overall score based on the one or more scores, determining the applicant's ranking in comparison to the pool of applicants, and outputting the rankings of the applicants.

In another aspect, a computing device for selecting participants from an applicant pool to participate in a program to exit poverty is described. The computing device includes a processor communicatively coupled to a memory device. The computing device is configured to store a plurality of questions to ask each applicant from a pool of applicants, store a plurality of ratings based on historical data wherein each rating is associated with each of one or more potential answers for each question of the plurality of questions, compile one or more scores for the applicant based on the applicant's answers to the plurality of questions and the plurality of ratings, calculate the applicant's overall score based on the one or more scores, determine the applicant's ranking in comparison to the pool of applicants, and output the rankings of the applicants.

In yet another aspect, a computer-readable storage medium having computer-executable instructions embodied thereon is described. When executed by a computing device having at least one processor coupled to a memory device, the computer-executable instructions cause the processor to store a plurality of questions to ask each applicant from a pool of applicants, store a plurality of ratings based on historical data wherein each rating is associated with each of one or more potential answers for each question of the plurality of questions, compile one or more scores for the applicant based on the applicant's answers to the plurality of questions and the plurality of ratings, calculate the applicant's overall score based on the one or more scores, determine the applicant's ranking in comparison to the pool of applicants, and output the rankings of the applicants.

### BRIEF DESCRIPTION OF THE DRAWINGS

FIGS. 1-4 show example embodiments of the methods and systems described herein.

FIG. 1 is a block diagram of an exemplary computing device.

FIG. 2 is a block diagram of the process of interviewing an applicant.

FIG. 3 is a high-level overview flowchart of the process for selecting applicants in accordance with one embodiment of this disclosure.

FIG. 4 is a detailed flowchart of the interaction between the AS computing device and the examiner during the selection process.

### DETAILED DESCRIPTION OF THE DISCLOSURE

The following detailed description illustrates embodiments of the disclosure by way of example and not by way of limitation. It is contemplated that the disclosure has general application to selecting applicants for participation in a program.

The systems and methods described herein relate to selecting applicants for participation in a program. More specifically, the systems and methods described herein are configured to a selection process to facilitate choosing participants who are most likely to succeed at a program that enables such participants to earn a wage and work their way out of poverty.

While in some contexts it may seem harsh to provide certain types of aid only to a select group of applicants living in poverty, to achieve the mission of providing assistance to lift people out of poverty, numerous realities have to be considered, including the reality that charitable organizations have limited resources. Determining the criteria to use, and then actually applying those criteria through interviews with numerous applicants, can be time consuming, burdensome, and without the correct criteria and appropriate interviewing and screening, likely ineffective.

Given the realities, including the difficulty in having meaningful communications with those living in poverty in at least some parts of the world, many charitable organizations are not overly selective when choosing to whom they provide assistance. However, when serving a mission to provide assistance to lift people out of poverty such lack of selectivity can result a depletion of the organizations resources without achieving the mission. Further, determining how to select participants in such a program can be extremely difficult and time consuming.

An organization could be more effective if it could direct its assistance and resources to those who would be the most successful both in the program and afterwards. Choosing those who are most likely to succeed can result in more of a positive impact on the local economy, rather than just spreading resources around. However, many organizations do not take the time or expend the effort to interview poor people in developing countries. Providing temporary relief or focusing on a specific circumstance or geographic area is easier for the organization, even if this approach may not achieve the organization's goals in the long run.

While many people want to participate in a program to help get themselves out of poverty, resources are finite. By helping those most likely to succeed in a program, the successful applicant's increased prosperity works to ripple out and help others in the community. To that end, the selection process narrows down a large pool of applicants quickly, efficiently, and effectively. To this extent, an Applicant Selection (AS) computing device is configured to rate the applicants based on each applicant's responses to questions.

In the example embodiment, an examiner interviews applicants from a pool of applicants for the program. During each interview, the AS computing device prompts the examiner to ask the applicant a series of questions stored in a memory that is communicatively connected to the AS computing device. The examiner enters each answer into the AS computing device, which stores the answer and assigns the answer a pre-determined value based on a table of possible answers and associated values. The AS computing device applies the assigned value to the score for the applicant. As the examiner asks more questions and receives answers, the AS computing device determines the values associated those answers and applies those determined values to update the applicant's score. At the end of the interview, the applicant is given a preliminary score and a ranking among the other applicants in the applicant pool. The AS computing device is configured to prompt the examiner to ask the applicant questions concerning three major categories: income, expenses, and intangible qualities. In the first category, the AS computing device evaluates the applicant's income, the income of the applicant's family, and any additional aid or income that the applicant receives. The AS computing device compares the applicant's income to that of the other applicants, assigns values to the applicant's score based on how the applicant's income compares to the other applicants, and calculates a total income score for the applicant. In evaluating expenses, the AS computing device counts the number and types of dependents that the applicant is responsible for, as well as school fees and other expenses to calculate a total expenses score for the applicant.

After evaluating income and expenses, the AS computing device may combine the applicant's total income score with the applicant's total expenses score to calculate a total need score for the applicant.

The AS computing device also evaluates the intangible qualities of the applicant, which are not as easily quantifiable as those in the other two categories. In the example embodiment, the examiner determines if the applicant has entrepreneurial spirit, weaving ability, and/or appropriate behavior for certain criteria for the applicant's region. These qualities are not all required for an applicant to succeed in the program, but the more of these qualities that an applicant has, the more likely the applicant is to be successful in the program and exit poverty. The examiner enters these determinations in the AS computing device. For select qualities possessed by an applicant, a pre-determined value associated with that quality is utilized in determining the applicant's score.

The AS computing device, also allows the examiner to include his or her personal perceptions of the applicant. If the examiner believes that the applicant has a very good chance of success in the program, then the examiner can enter a wildcard indicator into the AS computing device. When the wildcard indicator is received, the AS computing device applies a pre-determined value to the applicant's score. This pre-determined value is used to counteract for deficiencies in other areas of the applicant's score.

At the end of the interview, the AS computing calculates a preliminary score for the applicant by combining all of the values associated with the applicant's answers. Next the AS computing device calculates a preliminary rank for the applicant by comparing the applicant's preliminary score against the preliminary scores of the rest of the applicants. These ranks facilitate the selection of applicants from the applicant pool for the program.

In this embodiment, after the interview, the examiner follows up with the highest scoring applicants by visiting the applicant at his or her home. At this interview, the examiner may use the AS computing device to check the honesty of the applicant's answers in the interview by reviewing the stored answers against only investigations that the examiner performs. If the examiner discovers that an applicant has been intentionally dishonest in terms of assets, dependents, or in any way, the dishonest applicant is immediately removed from the selection process. The home visit also allows the examiner to adjust the rankings of the applicants. If there is only one spot left in the program and there are two applicants whose scores are very close, a home visit may allow the examiner to choose between the two applicants. As a result of the home visit, the examiner may change one or more of the applicant's answers. After these adjustments from the home visits, the AS computing device calculates the final scores using the assigned values and then uses the final scores to calculate the rankings for each applicant to enable selecting which applicants to admit to the program.

The methods and systems described herein may be implemented using computer programming or engineering techniques including computer software, firmware, hardware, or any combination or subset wherein a technical effect of the systems and processes described herein is achieved by performing at least one of the following steps: (a) providing an applicant selection computing device in communication with a memory; (b) storing, in the memory, a plurality of questions to ask an applicant to a charity program; (c) storing, in the memory, a plurality of ratings based on historical data wherein the ratings are used to calculate the applicant's likelihood of success in the charity program; (d) compiling, by the computing device, one or more scores for the applicant based on the applicant's answers to the plurality of questions and the plurality of ratings, the one or more scores including: (d1) an income score, which is based on the current income of the applicant including the income for the applicant and the applicant's family members and any aid the applicant is receiving from other sources; (d2) an expenses score, which is based on the current expenses of the applicant including number of dependents and school fees; and (d3) an intangibles score, which is based on the applicant's intangible qualities, including spirit, artisan ability, and behavior; (e) calculating, by the computing device, the applicant's overall score based on the one or more scores; (f) determining the applicant's ranking in comparison to one or more applicants for the charity program; (g) modifying the applicant's overall score based on the results of a visit to the applicant's home; and (h) outputting the rankings of the applicants to the charity program.

In one embodiment, a computer program is provided, and the program is embodied on a computer readable medium. In an example embodiment, the system is executed on a single computer system, without requiring a connection to a server computer. In a further example embodiment, the system is run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

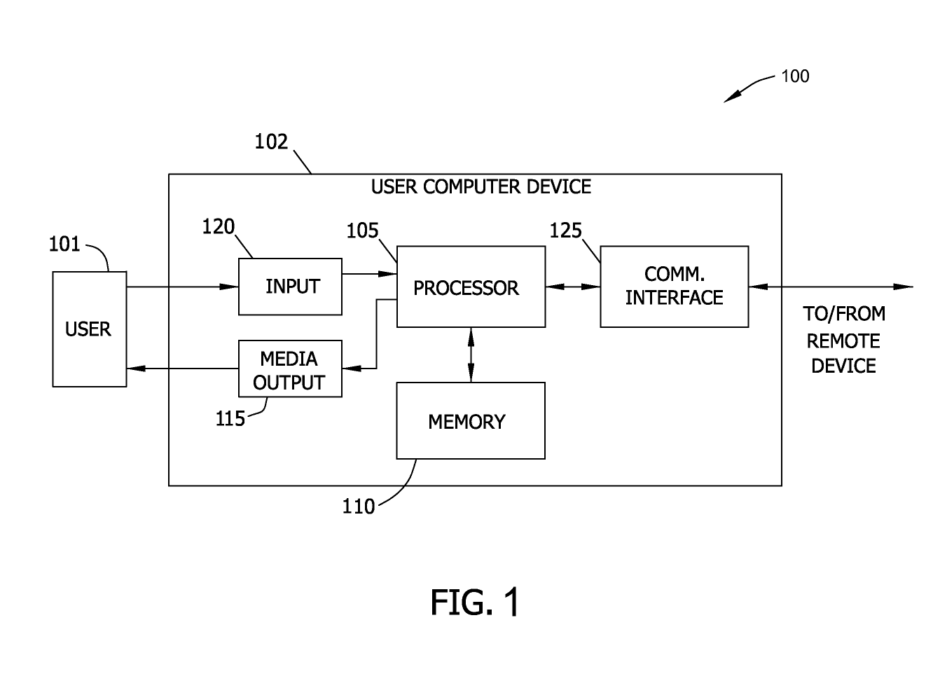

FIG. 1 is a block diagram of an exemplary computing device 100. The generic computing device 100 represents various forms of digital computers, such as laptops, desktops, workstations, personal digital assistants, servers, blade servers, mainframes, tablets, and other appropriate computers. Computing device 100 is also intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

User computer device 102 is operated by a user 101. User computer device 102 includes a processor 105 for executing instructions. In some embodiments, executable instructions are stored in a memory area 110. Processor 105 may include one or more processing units (e.g., in a multi-core configuration). Memory area 110 is any device allowing information such as executable instructions and/or transaction data to be stored and retrieved. Memory area 110 may include one or more computer readable media.

User computer device 102 also includes at least one media output component 115 for presenting information to user 101. Media output component 115 is any component capable of conveying information to user 101. In some embodiments, media output component 115 includes an output adapter (not shown) such as a video adapter and/or an audio adapter. An output adapter is operatively coupled to processor 105 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 115 is configured to present a graphical user interface (e.g., a web browser and/or a client application) to user 101. A graphical user interface may include, for example, an online store interface for viewing and/or purchasing items, and/or a wallet application for managing payment information. In some embodiments, user computer device 102 includes an input device 120 for receiving input from user 101. User 101 may use input device 120 to, without limitation, select and/or enter one or more items to purchase and/or a purchase request, or to access credential information, and/or payment information. Input device 120 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 115 and input device 120.

User computer device 102 may also include a communication interface 125, communicatively coupled to a remote device. Communication interface 125 may include, for example, a wired or wireless network adapter and/or a wireless data transceiver for use with a mobile telecommunications network.

Stored in memory area 110 are, for example, computer readable instructions for providing a user interface to user 101 via media output component 115 and, optionally, receiving and processing input from input device 120. A user interface may include, among other possibilities, a web browser and/or a client application. Web browsers enable users, such as user 101, to display and interact with media and other information typically embedded on a web page or a website. A client application allows user 101 to interact with, for example, a server system. For example, instructions may be stored by a cloud service, and the output of the execution of the instructions sent to the media output component 115.

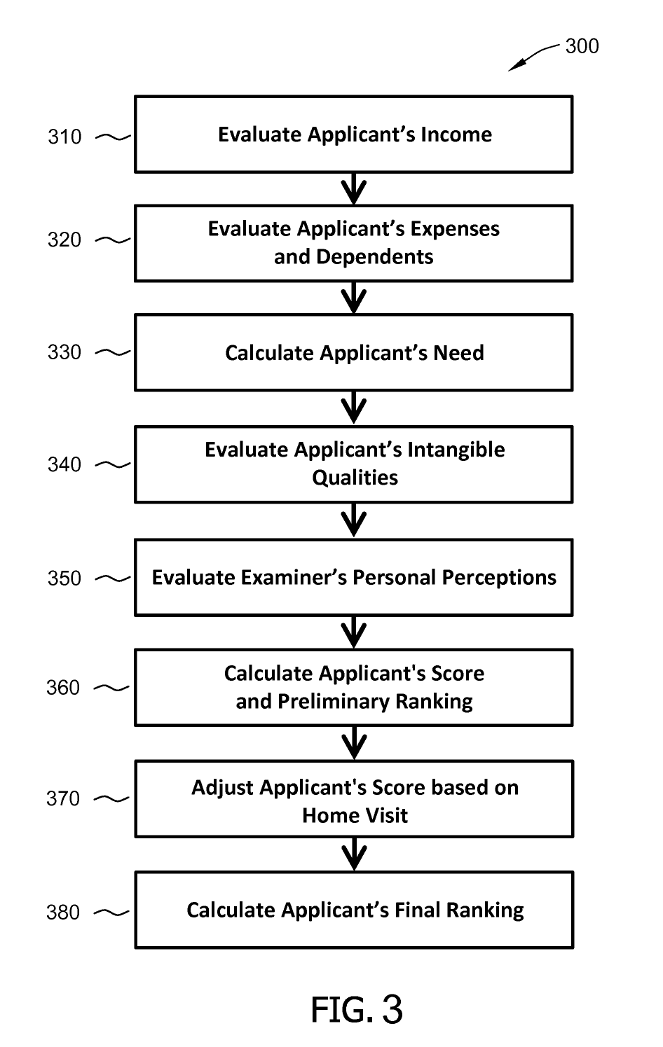

Processor 105 executes computer-executable instructions for implementing aspects of the disclosure. In some embodiments, the processor 105 is transformed into a special purpose microprocessor by executing computer-executable instructions or by otherwise being programmed. For example, the processor 105 can be programmed with the instruction such as illustrated in FIG. 3.

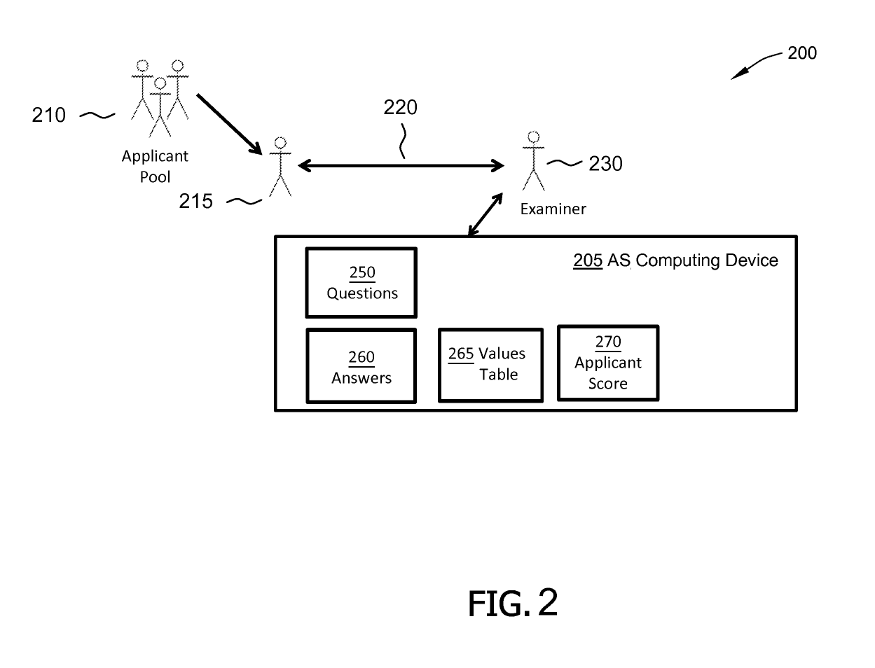

FIG. 2 is a block diagram of the process of interviewing 200 an applicant 215. In this example, the applicant 215 is chosen from a pool of applicants 210 to interact 220 with an examiner 230. The examiner 230 may be a single person or multiple people. In this embodiment, the interaction 220 between the examiner 230 and the applicant 215 is face-to-face. In other embodiments, the interaction 220 between the examiner 230 and the applicant 215 may be through other forms of communication such as over a phone or via video chat on the computer; however, face-to-face communication generally provides a robust venue for the examiner 230 to directly observe the applicant 215.

The examiner 230 uses an applicant selection (AS) computing device 205 during the examination 200. The AS computing device 205 is similar to the computing device 102 shown in FIG. 1. The AS computing device 205 includes a database having questions 250 stored therein, a listing of each applicant's answers 260, a values table 265, and a score 270 associated with each applicant 215. The database of questions 250 contains questions for the examiner 230 to ask to the applicants 215. These questions may be stand-alone or may be chains of questions, including follow-up questions. The database of questions 250 also includes questions to the examiner 230 about the examiner's observations of the applicant 215. In this embodiment, the questions are divided into three main categories: income, expenses, and intangible qualities.

The values table 265 contains one or more potential answers for each question in the database of questions 250 and values for each of these answers. Some of the values from the values table 265 may be pre-determined, while others may be calculated by the AS computing device 205. When an answer is received, the AS computing device 205 stores the answer in the answer listing 260 for that applicant 215 and then references the values table 265 to retrieve the value associated for that particular answer. The AS computing device 205 then applies the retrieved value to the score 270 for the applicant 215.

In one embodiment, the interview process may proceed as follows. The AS computing device 205 retrieves a question from the question database 250. The AS computing device 205 displays the question to the examiner 230 so that the examiner 230 may ask the question to the applicant 215. When the applicant 215 responds to the question, the examiner 230 enters the applicant's answer 260 into the AS computing device 205. Then the AS computing device 205 stores the answer in the applicant's answer listing 260, compares the answer 260 to the values table 265 to retrieve the value for that answer 260, applies the retrieved value to the applicant's score 270, and stores the result in the memory area 110. Next, the AS computing device 205 retrieves and displays another question from the question database 250 for the examiner 230. When the interview is complete, the AS computing device 205 calculates the applicant's score 270 based on the values of the applicant's answers and displays that applicant's score 270 to the examiner 230. The interview process is repeated for each applicant 215 in the applicant pool 210.

FIG. 3 is a high-level overview flowchart of the process 300 for selecting applicants in accordance with one embodiment of this disclosure. First, the AS computing device 205 evaluates the applicant's income 310 through a series of questions asked to the applicant 215. Each of the applicant's answers is assigned a value from the values table 265. Then a total income score is calculated for the applicant's income based on the values from the applicant's answers. In the example embodiment, these questions may include the applicant's personal income, the income of the applicant's family members, and any aid or other income that the applicant 215 is receiving. In this embodiment, the values for the applicant's income are based on the applicant's income compared to the other applicants' incomes. The AS computing device 205 may update the income values for all of the applicants every time that another applicant is interviewed. In other embodiments, the income values may be updated once all of the interviews are complete. For example, Applicant A may respond to a question that she receives no aid for school fees. After the examiner 230 enters her answer in the AS computing device 205, the AS computing device 205 assigns that answer a 0 value. Then Applicant A is then asked what her monthly income is and any other monthly family income she may have, to which she replies 4000 of the local currency for herself and 1000 for her family. After this information has been entered, the combined income is compared to the combined income of all of the applicants in the applicant pool 210. If the applicant's combined income is in the top quarter then a 7 is assigned, if in the second quarter a 6, in the third quarter a 4, and in the bottom quarter a 3. The aid for school fees and other income values, if any, would be added in as well. In this case, Applicant A is in the third quarter and the AS computing device 205 calculates her total income score to be a 4.

Through another series of questions the AS computing device 205 evaluates the applicant's expenses and dependents 320. The answers to these questions are assigned values from the table of values 265. Then the AS computing device 205 calculates a total expenses score based on the assigned values. Questions may include the number and type of dependents that the applicant 215 has, school fees that the applicant 215 is required to pay, or other potential expenses. For example, the Applicant A is asked how many dependent children she has. She replies 2. The examiner 230 enters the numbers into the AS computing device 205. The AS computing device 205 stores the number and assigns the answer a value of 2, or 1 per dependent child. Applicant A is next asked the number of elderly dependents that she is responsible for, to which Applicant A replies 1. The AS computing device 205 assigns that answer a value of 1 as well. When Applicant A is asked about the number of adult dependents, she replies 0, and the AS computing device 205 keeps the value at 0. Next Applicant A is asked how many of her dependents are sick, to which Applicant A answers 2. For each sick dependent, the AS computing device 205 applies another 0.5 to Applicant A's expenses score. After finding out that Applicant A is responsible for 2 sets of schools fees (assigning another 1 to the score for each school fee that is not covered by outside aid) and has no other expenses, the AS computing device 205 calculates the Applicant A's total expenses score to be 6, i.e., 2 for the dependent children, plus 1 for the elderly dependent, plus 1.0 for the two dependents that are sick, plus 2 for the school fees, equals a total expenses score of 6.

The AS computing device 205 uses the applicant's total income score and total expenses score to calculate the applicant's need 330. In the above example, the AS computing device 205 subtracts the applicant's total income score from the applicant's total expenses score. Next the AS computing device 205 subtracts the above difference from 10. The result is the applicant's total need score. In Applicant A's case, her total income score was a 4 and her total expenses score was a 6. This gives her a total need score of 10−(4−6)=12.

Next the AS computing device 205 evaluates the applicant's intangible qualities 340. Each applicant 215 has many different qualities that may contribute to his or her potential for success in the program; however, these skills cannot be quantified as neatly as the applicant's income. In this embodiment, the intangible properties of the applicant 215 are based on the observations of the examiner 230. In this case, the intangible qualities that the examiner 230 is evaluating the applicant 215 for are spirit, weaving ability, and behavior. The examiner 230 enters on the AS computing device 205 if the applicant 215 possesses each quality. The AS computing device 205 assigns a value to the presence or absence of each quality. For spirit, the examiner 230 looks at the applicant 215 for proven or implied entrepreneurial activity, in other words entrepreneurial spirit. For weaving ability, the applicant 215 is tested to see if he or she can weave at the standards for the program. The criteria for behavior are very country-specific. For example, women in one country may be culturally divisive and non-supportive of each one another. The examiner 230 would be looking for women that are non-divisive and helped their neighbors, a rare quality in women from that particular country. If any applicant has a strong positive reputation that precedes him or her from his or her village, the examiner 230 would enter into the AS computing device 205 that the applicant met the desired criteria for the behavior quality. While in this embodiment the presence of these qualities is being tested, in other embodiments the quantity of these qualities could be tested. For example, weaving ability could be evaluated on a scale rather than a yes or no. When entered into the AS computing device 205, the presence or absence of each of these qualities is assigned a different value. In Applicant A's case, the AS computing device 205 may assign a 3 if she meets the criteria for spirit, a 1 if she has weaving ability, and a 2 if she meets the criteria for behavior.

The next item entered into the AS computing device 205 is a wildcard indicator, where the examiner 230 evaluates 350 his or her personal perceptions of the applicant 215. There are qualities of an applicant 215 that defy the examination process, where the examiner 230 feels, that despite what the numbers say, a particular applicant 215 has a very good chance of succeeding in the program. The wildcard indicator may be used when the applicant 215 does something that shows a strong spirit or boldness. In one embodiment, if Applicant A sits down at the interview and rather than speaking only to the examiner 230, who speaks the local language, speaks directly to the out-of-country team that is observing, that may indicate a strong spirit or boldness. Although neither group speaks the other's language, the fact that Applicant A is uninhibited and bold enough to talk directly to the out-of-country team earns her the wildcard indicator. When the examiner 230 enters the wildcard indicator into the AS computing device 205, the AS computing device 205 assigns a value to offset deficiencies in other areas of the examination. This allows for applicants 215 who would otherwise be passed to be given a chance if the examiner 230 has the impression they are likely to succeed in the program. In this embodiment, the wildcard indicator is limited by the observations of the examiner 230.

Next the AS computing device 205 compiles all of the values in a formula to calculate 360 the score 270 for the applicant 215. This score 270 assists the examiner 230 in determining if the applicant 215 is likely to succeed in the program. Then the score is compared to the scores of all of the other applicants in the applicant pool 210 to determine the applicant's preliminary ranking. The rankings facilitate selecting applicants for participation in the program. For example, Applicant A has a total need score of 12. To the total need the AS computing device 205 applies the values for possessing spirit (3), weaving ability (1), and the wildcard (3) for a total score 270 of 19. In this embodiment, this total score 270 is extremely high, so the applicant 215 is likely to be highly ranked and be accepted into the program.

After the interview, the examiner 230 follows up with the applicant 215 by visiting the applicant's home. This home visit allows the examiner 230 to adjust the applicant's score 270 and/or ranking 370. In some cases, two or more applicants may be tied or have a score difference of only one point. In deciding which applicants to accept to the program, a home visit gives the examiner 230 more information. The home visit also allows the examiner 230 to evaluate the applicant's honesty in his or her answers. The home visit is also helpful in deciding if the applicant 215 deserves the wildcard indicator. On a home visit an examiner 230 may be able to compare the applicant's answers from the AS computing device 205 with the evidence presented before the examiner 230. For example, Applicant A has been the highest ranked applicant in the interview part of the process. But when the examiner 230 visits Applicant B's home, the examiner 230 discovers that Applicant A owns a sizeable piece of land that the applicant 215 is not using. This discovery leads the examiner 230 to check the truthfulness of Applicant A's other answers. At this point, the Applicant A has shown that she is not using her resources to their best potential, thus leading the examiner 230 to have serious doubts about Applicant A's ability to succeed in the program. Applicant's A ranking may be lowered. If the examiner 230 discovers that Applicant A was not honest with the examiner 230 then Applicant A would be dismissed from the selection process. In a different example, Applicant B has a tiny area of land that she owns, but uses the land very effectively to grow as many vegetables as possible. This may indicate to the examiner 230 that Applicant B has a high probability of succeeding in the program.

After the home visits, the AS computing device 205 calculates the applicants' final rankings 380. Space in charity programs is limited and resources are finite, so it is important to take the highest ranked applicants, the most likely to succeed.

While the above embodiment listed specific values and formula to calculate the applicant's score 270, in other embodiments, other values or formulas may be employed. In some embodiments, values and formulas may be updated based on historical data or based on differences in regional locations.

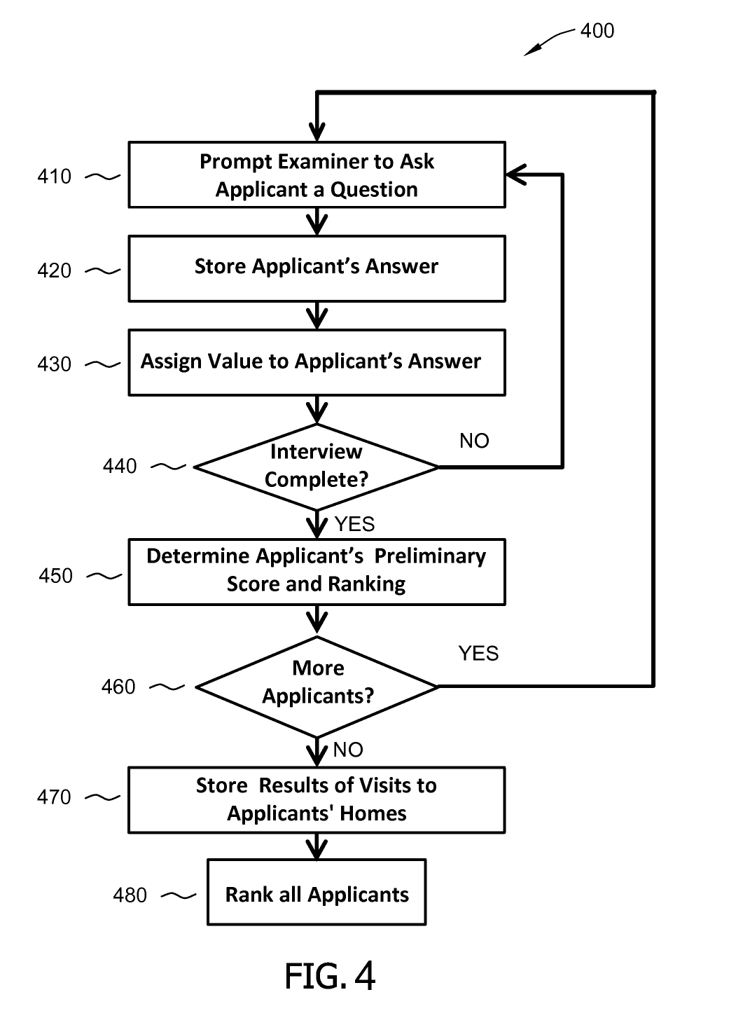

FIG. 4 is a detailed flowchart of the interaction 400 between the AS computing device 205 and the examiner 230 during the selection process. The AS computing device 205 prompts 410 the examiner 230 to ask the applicant 215 a question from the database of questions 250 that the AS computing device 205 has stored in the memory area 110. When the examiner 230 gets an answer to the question, the examiner 230 enters that answer into the AS computing device 205 using the user input interface 120. The AS computing device 205 stores the answer 420 in the applicant's answer listing 260 and then assigns the answer a value 430 based on the value table 265 (as shown in FIG. 2).

The AS computing device 205 then checks to see if the interview is complete 440. In some embodiments, the AS computing device 205 receives an indicator from the examiner 230 noting the completion of the interview. In other embodiments, the AS computing device 205 monitors the questions being answered and concludes the interview after a pre-determined last question has been answered. If the examination is not complete, then the AS computing device 205 prompts 410 the examiner 230 to ask a different question from the question database 250. Otherwise the AS computing device 205 determines the applicant's preliminary score 270 (based on the values of the applicant's answers) and ranking 450 (based on a comparison of the scores of the other applicants). To calculate the score 270, the AS computing device 205 applies the values associated with the applicant's answers to a formula to determine a numerical score.

The AS computing device 205 checks to see if there are still more applicants to interview 460. In some embodiments, the AS computing device 205 receives a list of the applicants to be interview. If there are more applicants, then the AS computing device 205 goes back to step 410 and prompts the examiner 230 to ask a question to the next applicant 215. Otherwise, the AS computing device 205 next stores the results of the examiner's visits to the applicants' homes 470. Once the home visits are complete, the AS computing device 205 ranks all of the applicants for the program 480.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for selecting participants from an applicant pool to participate in a program to exit poverty, said method implemented using a computer device in communication with a memory, said method comprising:
storing, in the memory, a plurality of questions to ask each applicant from a pool of applicants;
storing, in the memory, a plurality of ratings based on historical data, wherein each rating is associated with each of one or more potential answers for each question of the plurality of questions;
compiling, by the computing device, one or more scores for the applicant based on the applicant's answers to the plurality of questions and the plurality of ratings;
calculating, by the computing device, the applicant's overall score based on the one or more scores;
determining the applicant's ranking in comparison to the pool of applicants; and
outputting the rankings of the applicants.

2. The method in accordance with claim 1, wherein one of the one or more scores is an income score, which is based on the current income of the applicant.

3. The method in accordance with claim 1, wherein one of the one or more scores is an expenses score, which is based on the current expenses of the applicant.

4. The method in accordance with claim 1, wherein one of the one or more scores is an intangibles score, which is based on the intangible qualities of the applicant.

5. The method in accordance with claim 1 further comprising modifying the applicant's overall score based on the results of a visit to the applicant's home.

6. The method in accordance with claim 1 further comprising prompting the applicant to answer a question from the plurality of questions.

7. The method in accordance with claim 1, wherein compiling one or more scores further comprises:
receiving and storing an answer from the applicant;
retrieving a rating from the plurality of ratings which is associated with the answer; and
applying the rating to a score.

8. A computing device for selecting participants from an applicant pool to participate in a program to exit poverty, said computing device comprising a processor communicatively coupled to a memory device, said computing device configured to:
store a plurality of questions to ask each applicant from a pool of applicants;
store a plurality of ratings based on historical data, wherein each rating is associated with each of one or more potential answers for each question of the plurality of questions;
compile one or more scores for the applicant based on the applicant's answers to the plurality of questions and the plurality of ratings;
calculate the applicant's overall score based on the one or more scores;
determine the applicant's ranking in comparison to the pool of applicants; and
output the rankings of the applicants.

9. The computing device of claim 8, wherein one of the one or more scores is an income score, which is based on the current income of the applicant.

10. The computing device of claim 8, wherein one of the one or more scores is an expenses score, which is based on the current expenses of the applicant.

11. The computing device of claim 8, wherein one of the one or more scores is an intangibles score, which is based on the intangible qualities of the applicant.

12. The computing device of claim 8, further configured to modify the applicant's overall score based on the results of a visit to the applicant's home.

13. The computing device of claim 8, further configured to prompt the applicant to answer a question from the plurality of questions.

14. The computing device of claim 8 further configured to:
receive and store an answer from the applicant;
retrieve a rating from the plurality of ratings which is associated with the answer; and
apply the rating to a score.

15. A computer-readable storage medium having computer-executable instructions embodied thereon, wherein when executed by a computing device having at least one processor coupled to a memory device, the computer-executable instructions cause the processor to:
store a plurality of questions to ask each applicant from a pool of applicants;
store a plurality of ratings based on historical data, wherein each rating is associated with each of one or more potential answers for each question of the plurality of questions;
compile one or more scores for the applicant based on the applicant's answers to the plurality of questions and the plurality of ratings;
calculate the applicant's overall score based on the one or more scores;
determine the applicant's ranking in comparison to the pool of applicants; and
output the rankings of the applicants.

16. The computer-readable storage media in accordance with claim 15, wherein one of the one or more scores is an income score, which is based on the current income of the applicant.

17. The computer-readable storage media in accordance with claim 15, wherein one of the one or more scores is an expenses score, which is based on the current expenses of the applicant.

18. The computer-readable storage media in accordance with claim 15, wherein one of the one or more scores is an intangibles score, which is based on the intangible qualities of the applicant.

19. The computer-readable storage media in accordance with claim 15, wherein the computer-executable instruction cause the processor to modify the applicant's overall score based on the results of a visit to the applicant's home.

20. The computer-readable storage media in accordance with claim 15, wherein the computer-executable instruction cause the processor to:
receive and store an answer from the applicant;
retrieve a rating from the plurality of ratings which is associated with the answer; and
apply the rating to a score.
